(19) United States
(12) Patent Application Publication
(10) Pub. No.: US 2001/0008682 A1
(43) Pub. Date: Jul. 19, 2001

(54) ELECTROPHOTOGRAPHIC TRANSFER SHEET AND IMAGE FORMATION METHOD USING THE SAME

(76) Inventors: KIYOSHI HOSOI, EBINA-SHI (JP); RYOSUKE NAKANISHI, EBINA-SHI (JP); CHIZURU KITAOKA, EBINA-SHI (JP); MASARU KATO, CHUO-KU (JP); AKIRA NAKAMURA, CHUO-KU (JP); SHUICHI MAEDA, CHUO-KU (JP); MASAKAZU HAKOMORI, CHUO-KU (JP)

Correspondence Address: OLIFF & BERRIDGE, P O BOX 19928, ALEXANDRIA, VA, 22320

(21) Appl. No.: 09/236,473

(22) Filed: Jan. 25, 1999

(30) Foreign Application Priority Data
Feb. 2, 1998 (JP) HEI. 10-20608
Sep. 16, 1998 (JP) HEI. 10-261096

(51) Int. Cl. B32B 3/00; B32B 27/14

(52) U.S. Cl. 428/195

(57) ABSTRACT

An electrophotographic transfer sheet is disclosed, comprising a support having on at least one surface thereof a porous coating layer formed of a resin, wherein the volume of voids having a pore size of 10 μm or more determined by a mercury press fitting method is from 7 to 50 ml/m². Further disclosed is a method for forming a full color image using the electrophotographic transfer sheet.

### BACKGROUND OF THE INVENTION

The present invention relates to a transfer sheet used as a transferee material in a copying machine or printer of indirect dry electrophotographic system and relates to a method for forming an image by using a toner and fixing it on the transfer sheet under pressure and heat.

With introduction of color systems or digitization of electrophotographic copying machines or printers, studies have heretofore been made to attain a high-quality electrophotographic image. In particular, the operation of inputting or outputting an image is being digitized in electrophotographic full color copying machines or printers for obtaining a high-quality image. Due to this, the image inputting method and the processing, development, fixing and the like of the image after the input are greatly improved. Furthermore, the developer and the photoreceptor are also improved to keep up with the digital color recording of high precision and high color formation.

However, the electrophotographic full color copying machines or printers have a problem that since a toner having a particle size of from several μm to tens of μm is used, when a wood free paper or a coated paper is used as the image support, the toner is heaped up and the gloss increases at the toner high density area and decreases at the low density area. As a result, the gloss on the toner image surface becomes uneven and the image obtained is inferior in the image quality to the photographic image or printed image. Furthermore, differently from a photograph or printed matter, the image has a difference in the height level due to the toner and unevenness in the height of the image gives a strange feeling.

In the electrophotographic full color copying machines or printers, a toner having a highly sharp melting property is used so as to satisfy the requirements for the melting property and color mixing property of the toner. When this kind of toner is applied to a plain paper, the fused toner excessively enters the void between fibers of the paper to deteriorate the graininess. In the case of a coated paper, the fused toner scarcely permeates into the paper and accordingly, the fused toner extends transversely to also deteriorate the graininess. As such, whichever is used, the use of a plain paper or a coated paper has a problem that the image is inferior to the photographic image or printed image.

In order to solve the above-described problems, the Unexamined Japanese Patent Application Publication No. Hei 9-171266 discloses a method of providing a void layer for absorbing the toner on the image support and embedding the toner into the void layer by a fixing unit to thereby reduce the gloss of the image. The method of embedding the toner into the void layer is somewhat effective in inhibiting the healing of the toner, however, the paper having a void layer readily sticks to or winds around the fixing unit at the fixing, as a result, the fixing unit may be damaged or a correct image may not be obtained. Moreover, in a low humidity environment, image defects such as discharge mark may be generated.

The Unexamined Japanese Patent Application Publication No. Hei 5-297621 discloses a method of coating a slight amount of a pigment on the base paper to provide regular voids on the paper surface and fixing the toner inside the voids. However, the coating of a pigment in a slight amount cannot ensure a sufficiently large amount of voids and in the case of a second or third color having a large toner amount, the toner cannot be absorbed. In particular, the solid area cannot be prevented from the healing of the toner and is increased in the gloss, thus, the gloss unevenness or the graininess cannot be improved.

The Unexamined Japanese Patent Application Publication No. Hei 8-171306 discloses a method of controlling the image gloss by the fixing conditions in an image formation apparatus. The method of controlling the image gloss by the fixing conditions, however, cannot eliminate the difference in height level between the image area and the white background area, as a result, the difference in the height of the image remains and the problem of strange feeling of the image cannot be overcome.

### SUMMARY OF THE INVENTION

The object of the present invention is to solve the above-described problems and provide an electrophotographic transfer sheet which is free of gloss unevenness on the surface of an image, reduced in the image gloss, liberated from the strange feeling due to difference in the toner image height, excellent in the graininess, inhibited from winding around a fixing unit, prevented from generation of discharge marks in a low humidity environment, and capable of obtaining an excellent full color image, and further a method for forming an image using the transfer sheet.

These objects have been attained by using the following constitutions:

(1) An electrophotographic transfer sheet comprising a support having on at least one surface thereof a porous coating layer formed of a resin, wherein the volume of voids having a pore size of 10 μm or more determined by a mercury press fitting method is from 7 to 50 ml/m².

(2) The electrophotographic transfer sheet as described in (1), wherein the support has a basis weight according to JIS P8124 of from 70 to 180 g/m².

(3) The electrophotographic transfer sheet as described in (1) or (2), wherein the support has a Beck smoothness of from 20 to 5,000 seconds.

(4) The electrophotographic transfer sheet as described in any one of (1) to (3), wherein the CD stiffness determined by the Clark method according to JIS P8143 is 40 cm³/100 or more.

(5) The electrophotographic transfer sheet as described in any one of (1) to (4), wherein the moisture content immediately after unsealing according to JIS P8127 is from 4.5 to 6.0%

(6) The electrophotographic transfer sheet as described in any one of (1) to (5), wherein the transfer sheet is used for the full color electrophotographic process.

(7) A method for forming a full color image, comprising transferring and then fixing a toner image on an electrophotographic transfer sheet comprising a support having on at least one surface thereof a porous coating layer formed of a resin, wherein the electrophotographic transfer sheet is a transfer sheet described in any one of (1) to (5) is used and the toner image height from the surface of the porous coated layer is adjusted to 2 μm or less.

(8) A method for forming a full color image, comprising transferring and fixing a toner image on an electrophotographic transfer sheet comprising a support having on at least one surface thereof a porous coating layer formed of a resin, wherein the electrophotographic transfer sheet is a transfer sheet described in (6) and the image on the transfer sheet after the transfer and fixing under pressure and heat has a maximum glossiness of 35% or less, a gloss difference (maximum glossiness—minimum glossiness) of 30% or less and a toner image height of 2 μm or less.

The present inventors have made extensive studies on the structure and the void amount of the transparent resin layer in the electrophotographic transfer sheet as well as on the CD stiffness and moisture content immediately after unsealing of the transfer sheet, so that in the formation of an image by an electrophotographic process, particularly a full color image, the gloss unevenness and low glossiness of the image, the strange feeling due to the image height, the graininess, the winding of the transfer sheet around a fixing unit, and the image defects in a low humidity environment can be improved. As a result, they have found that these problems can be solved by the above-described constitutions. The present invention has been accomplished based on this finding.

### BRIEF DESCRIPTION OF DRAWING

FIG. 1 is a schematic cross section showing an indirect dry electrophotographic apparatus for implementing the image formation method of the present invention.

### DETAILED DESCRIPTION OF THE PREFERRED EMBODIMENTS

The support which can be used for the electrophotographic transfer sheet of the present invention includes papers such as paper mainly comprising pulp, coated paper and laminated paper, cloths such as woven fabric and non-woven fabric, plastic films such as polyolefin, methacrylates and cellulose acetates, synthetic papers comprising polyolefin and a pigment, and porous synthetic resin films such as foamed polyethylene terephthalate film and foamed polypropylene film. In the case where a paper mainly comprising pulp, such as coated paper, is used as the support, the paper can be advantageously recycled.

The support for use in the electrophotographic transfer sheet of the present invention suitably has a basis weight according to JIS P8124 of from 70 to 180 g/m², preferably from 80 to 150 g/m². More specifically, wood free paper, medium-quality paper, plain paper such as recycled paper, printing coated paper, art paper and cast-coated paper may be used, however, the present invention is by no means limited thereto. If the basis weight is less than 70 g/m², the paper is unnerved for a transfer sheet and in the case of using a roller-type fixing unit, the sheet readily winds around the roll or is greatly curled after the fixing of the toner. On the other hand, if the basis weight exceeds 180 g/m², a heat capacity sufficiently large to embed the toner into the image-receiving layer of a transfer sheet cannot be obtained and gloss unevenness may be generated.

A so-called coated paper obtained by applying a coating material mainly comprising a pigment and an adhesive to the paper surface and subjecting the surface to smoothing treatment such as supercalendering, may be particularly preferably used. In the present invention, when a coated paper is used as the support, the surface of a porous coated layer formed by coating a bubble-containing solution can be easily smoothed and thereby, the toner and the fixing roller can be tightly contacted with each other in a copying machine, as a result, mottles are scarcely generated and a very good recorded image can be obtained.

The support for use in the electrophotographic transfer sheet of the present invention suitably has a Beck smoothness of from 20 to 5,000 seconds, preferably from 40 to 4,000 seconds.

In the case where the support is a coated paper, if the Beck smoothness on the support thereof exceeds 5,000 seconds, the porous coated layer formed by coating a bubble-containing resin solution is poorly anchored to the support and accordingly, the support and the porous coated layer may be separated at the interface therebetween. On the other hand, if the Beck smoothness is less than 20 seconds, the porous coated layer may fail to have smoothness due to roughness on the support surface or may have an uneven thickness, as a result, the toner is unevenly transferred and this causes generation of mottles.

In the electrophotographic transfer sheet of the present invention, a coated layer comprising a porous film formed of a transparent resin is provided on at least one surface of a sheet-like support and the coated layer is rendered to have a predetermined amount of voids by adjusting the volume of voids having a pore diameter of 10 μm or more according to a mercury press fitting method to from 7 to 50 ml/m², so that the toner of a toner image can be absorbed into the void layer at the time of fixing and the solid area can be prevented from having high glossiness or the gloss unevenness can be improved. Furthermore, since the toner is absorbed, the toner cannot transversely extend and an image having excellent graininess can be provided. The void volume is preferably from 10 to 25 ml/m².

If the void volume is less than 7 ml/M², the fused toner on a high-density image area cannot sufficiently permeate into the inside of the coated layer due to the deficient void volume, as a result, it becomes impossible to have a maximum glossiness on an image area of 35% or less, a gloss difference (maximum glossiness—minimum glossiness) of 30% or less, a toner image height of 2 μm or less, and good graininess. On the other hand, if the void volume exceeds 50 ml/m², the fused toner excessively enters the voids due to a large amount of voids to fail in ensuring the graininess or the density is reduced to cause generation of discharge marks as an image defect at the time of transfer in a low humidity environment. The volume of voids having a pore diameter of 10 μm or more is determined by a mercury press fitting method using a mercury porosimeter.

Furthermore, a full color toner image is transferred and fixed under heat and pressure such that the maximum glossiness on an image area is 35% or less, the gloss difference (maximum glossiness—minimum glossiness) is 30% or less and the image height is 2 μm or less, whereby the gloss can be reduced, the image surface can be free of gloss unevenness, good graininess can be obtained and the strange feeling due to image height can be eliminated. The image height is preferably 1 μm or less, the maximum glossiness on an image area is preferably 30% or less, and the gloss difference is preferably 20% or less.

The electrophotographic transfer sheet having the above-described specific void volume has a CD stiffness determined by the Clark method according to JIS P8143, of 40 cm³/100 or more and thereby, the transfer sheet is improved in the winding property around or sticking to a fixing unit, which readily occur in the case of a coated paper having voids on the surface thereof. The CD stiffness is preferably 45 cm³/100 or more.

The electrophotographic transfer sheet having the above-described void volume is further adjusted to have a moisture content according to JIS P8127 of 4.5 to 6% immediately after unsealing of the transfer sheet on recording, so that generation of image defects such as discharge mark liable to occur in the case of a coated paper having a large amount of voids, can be inhibited. If this moisture content is less than 4.5%, discharge marks are generated, whereas if the moisture content exceeds 6.0%, transfer failure disadvantageously takes place. The above-described moisture content is preferably from 5.0 to 5.5%.

The porous film constituting the coated layer in the transfer sheet of the present invention mainly comprises a transparent resin or a transparent resin and a pigment. The coated layer can be formed by mechanically stirring a liquid material containing the resin and/or a pigment to allow a large number of fine bubbles to be generated in the liquid material and coating the resulting bubble-containing resin solution on a support.

The porous coated layer of the present invention is formed using a water-soluble resin or a water-dispersible resin. More specifically, polyvinyl alcohols having various molecular weights or saponification degrees, and derivatives thereof, various modified starches such as oxidized starch, and derivative thereof may be used. Examples of the water-soluble resin include various modified starches such as oxidized starch, cellulose derivatives such as methoxy cellulose, carboxymethyl cellulose, methyl cellulose and ethyl cellulose, sodium polyacrylate, polyvinyl pyrrolidone, acrylic acid amide-acrylic acid ester copolymers, acrylic acid amide-acrylic acid ester-methacrylic acid ester copolymers, alkali salts of a styrene-maleic anhydride copolymer, and polyacrylamide and derivatives thereof. Examples of the water-dispersible resin include latexes such as polyvinyl acetate, polyurethane, styrene-butadiene copolymers, acrylonitrile-butadiene copolymers, polyacrylic acid esters, vinyl chloride-vinyl acetate copolymers, polybutyl methacrylate, ethylene-vinyl acetate copolymers, styrene-butadiene-acryl copolymers and polyvinylidene chloride. In addition, glue, casein, soybean starch, gelatin, sodium alginate and the like may be used, however, the present invention is by no means limited thereto. These resins may be used, if desired, individually or in combination of two or more thereof.

Examples of the pigment which can be incorporated into the porous coated layer of the present invention include inorganic pigments such as zinc oxide, titanium oxide, calcium carbonate, silicate, clay, talc, mica, calcined clay, aluminum hydroxide, barium sulfate, lithopone, silica and colloidal silica; organic pigments called plastic pigments worked into various shapes, for example, a spherical, hollow, crenate, donut or flat form, such as polystyrene, polyethylene, polypropylene, epoxy resin and styrene-acryl copolymer; starch powder; and cellulose powder, however, the present invention is by no means limited thereto. These pigments may be used, if desired, individually or in combination of two or more thereof.

In the present invention, the formation and dispersion of bubbles (foaming) in the resin-containing solution may be performed using a stirrer with a stirring blade, capable of rotating rotates while making a planetary motion, such as foaming machine for confectionery, a stirrer commonly used for emulsification and dispersion, such as homomixer and Caules dissolver, or an apparatus capable of mechanically stirring a mixture of an air and a resin-containing solution while continuously feeding the mixture into a closed system, and thereby dispersion-mixing the air as fine bubbles, such as continuous foaming machine, however, the present invention is by no means limited thereto.

A bubble conditioner or a foaming agent may be added to the above-described resin-containing solution in the case where the mechanical stirring capability is deficient and a predetermined bubble-containing condition cannot be obtained or for improving the stability of bubbles in the bubble-containing solution. More specifically, higher fatty acids such as stearic acid and palmitic acid, higher fatty acid salts such as sodium lauryl sulfate, ammonium stearate and ammonium palmitate, and higher fatty acid modified products such as alkyl alkanolamide and sorbitan fatty acid ester, are particularly effective because of their high effect of elevating the foamability of the resin-containing solution and improving dispersion stability of bubbles. Selection of the bubble conditioner or foaming agent is not strictly limited, however, it is preferred not to use one which may seriously inhibit the flowability of the resin-containing mixed solution or the coating workability. The amount of the bubble conditioner or foaming agent blended is suitably, in terms of the solid content, from 0 to 30 parts by weight, preferably from 1 to 20 parts by weight, per 100 parts by weight of the solid content of the resin or the mixed solution of the resin and a pigment. Even if the amount of the bubble conditioner or foaming agent blended exceeds 30 parts by weight, the effect obtained by the addition does not increase any more.

The electric resistance on the surface of the porous coated layer of the present invention is usually adjusted by mixing thereto an electrically conducting agent, to from 1×10⁸ to 1×10¹² Ω, preferably from 1×10⁸ to 1×10¹¹ Ω, more preferably from 1×10⁹ to 1×10¹¹ Ω. If the surface electric resistance is less than 1×10⁸ Ω, the toner is poorly transferred to the transfer sheet in a high humidity environment and reduction in density or density unevenness is liable to occur, whereas if it exceeds 1×10¹² Ω, the toner readily splashes at the time of peeling the transfer sheet from the photoreceptor after the transfer of toner in a low humidity environment and the image may be disordered to result in poor image quality. Examples of preferred electrically conducting agents include sodium chloride, potassium chloride, salts of a styrene-maleic acid copolymer, and quaternary ammonium salt, however, the present invention is by no means limited thereto.

The porous coated layer may be formed on a support by a known method such as meyer bar coating, gravure roll coating, roll coating, reverse roll coating, blade coating, knife coating, air knife coating, extrusion coating or cast coating, and the coating method may be freely selected from these known methods.

The transfer sheet having a porous coated layer of the present invention may provide a good image even in the simple state where a bubble-containing resin mixed solution is coated and dried, however, by subjecting the porous coated layer further to finishing treatment using a supercalender consisting of an appropriate combination of a metal roller and a resin-made roller or a metal-made roller and a cotton-made roller, the surface of the porous coated layer can be more improved. Furthermore, the semi-dried or dried sheet after the coating may be contacted with a heated or semi-heated cast drum or the like subjected to mirror face finishing, to thereby further improve the surface smoothness of the porous coated layer.

However, if the above-described finishing treatment for smoothing the surface is performed under an excessively high pressure, the resin wall surrounding the bubbles of the porous coated layer may be ruptured to densify the coated layer and thereby reduce the heat insulating property or cushioning property, or the bubbles on the surface of the porous coated layer may be fractured and the porous coated layer may lose its excellent transfer performance. Accordingly, when the smooth finishing treatment is performed, the treatment conditions must be thoroughly contemplated.

At the time when the transfer sheet of the present invention is produced by coating a bubble-containing solution on a sheet-like support, the transfer sheet itself may be curled with the coated surface thereof facing inward or outward during the process of coating, drying, taking up or the like. In such a case, if the transfer sheet is used after the sheet is cut into an image formation sheet having a predetermined dimension, there may arise troubles such that the sheet is not normally fed into an image forming apparatus or travelling within the apparatus is inhibited.

In order to prevent such troubles caused by the curling, the difference in shrinkage or expansion on heating between the porous film and the support is preferably reduced as much as possible. To this purpose, a curl-preventing layer may be coated or laminated on the back surface of the transfer sheet, namely, the surface opposite to the porous coated layer. The material, formation method and coated or laminated amount of the curl-preventing layer are not limited and these may be optimally selected taking account of various factors such as the kind and thickness of the support or the properties, that is, material composition, foaming magnification and coated amount, of the porous coated layer.

Depending on the support material selected, the transfer sheet may be subject to various frictional forces in view of the mechanism of the apparatus during the travelling within the image formation apparatus, or may be electrostatically charged due to decrease of the humidity inside the apparatus on heating. Under such a condition, if image formation is continuously performed on a large number of sheets, the image formed surface of the transfer sheet and the back surface of the next transfer sheet electrostatically cohere to each other and cannot be easily separated. In particular, plastic sheet or synthetic paper of various types is in itself prone to electrification and accordingly, when such a plastic sheet or synthetic paper is used as the support, electrostatic charge is generated during the process of cutting into a sheet or during the storage after the working to inhibit smooth separation between the front surface of a transfer sheet and the back surface of another transfer sheet. Of course, such a trouble takes place also in the case where paper is used as the support.

In order to prevent such a trouble ascribable to the electrostatic charging, it is very effective to form a so-called antistatic layer on the back surface of the transfer sheet. Furthermore, use of an antistatic material or reduction of the friction coefficient between sheets (between the back surface of a transfer sheet and the porous coated layer (front surface of another transfer sheet)) is effective for preventing generation of troubles ascribable to the electrostatic charging. The material and the formation method of the antistatic layer may be appropriately selected from materials and methods over a wide range similarly to the formation of a curl-preventing layer.

The color image formation method is described below.

The toner for use in indirect dry full color electrophotographic copying machines or printers is required to exhibit good melting property and color mixing property on heating. To this effect, a sharp melting toner is preferably used.

The toner can be produced by melt-kneading, grinding and classifying toner constituent materials, for example, a binder resin such as polyester, a coloring agent and a charge controlling agent.

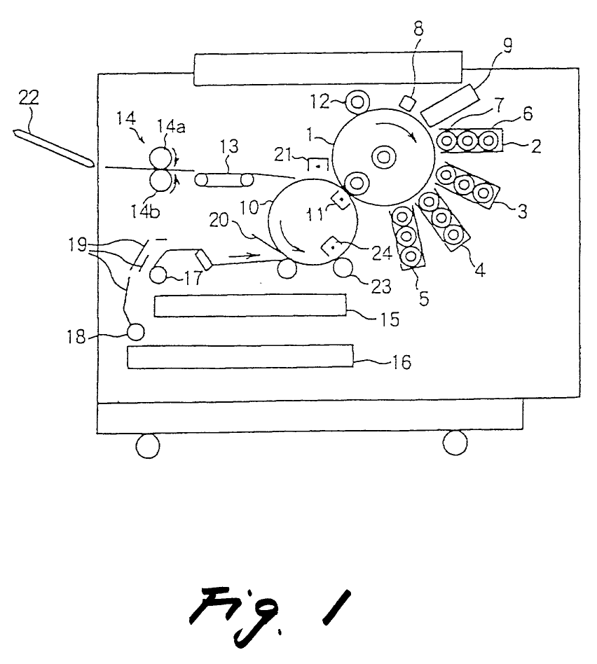

FIG. 1 is a schematic cross section showing an example of the electrophotographic apparatus for forming a full color image used in the present invention. The electrophotographic apparatus roughly consists of a transfer member transportation system provided over the area from the lower side of the apparatus body to the almost center part of the apparatus body, a latent image formation part provided in the nearly center part of the apparatus body to come close to the transfer drum 10 constituting the transfer member transportation system, and a development unit provided adjacent to the latent image formation part.

The transfer member transportation system comprises paper feed trays 15 and 16 disposed in the lower side of the apparatus body, paper feed rollers 17 and 18 disposed almost right above respective trays, paper guides 19 and 20 disposed adjacent to those paper feed rollers, a transfer drum 10 freely rotatable in the arrow direction disposed adjacent to the paper guide 20, a transfer member separating charge unit 21 disposed in the vicinity of the outer peripheral surface of the transfer drum, a transfer unit 11 and an electrode 24 disposed on the inner peripheral surface of the transfer drum, a contacting roller 23 contacted with the outer peripheral surface of the transfer drum, a transportation unit 13, a fixing unit 14 disposed in the vicinity of the distal end in the delivery direction of the transportation unit, and a discharge tray 22 capable of connection and disconnection.

The latent image formation part comprises an electrostatic latent image holding body (photoreceptor drum) 1 being freely rotatable in the arrow direction and disposed such that the outer peripheral surface thereof comes into contact with the outer peripheral surface of the transfer drum 10, a charge unit 8 disposed in the vicinity of the outer peripheral surface of the electrostatic latent image carrier, a writing unit 9 for forming an electrostatic latent image on the outer peripheral surface of the electrostatic latent image holding body, the writing unit having an image exposure means such as laser beam scanner and an image exposure reflection means such as polygon mirror, and a cleaning unit 12.

The development unit consists of a developer carrier 7 and a housing 6 and comprises a black developing machine 2, a magenta developing machine 3, a cyan developing machine 4 and a yellow developing machine 5 disposed at the sites opposing the outer peripheral surface of the electrostatic latent image holding body 1 for visualizing the electrostatic latent image formed on the outer peripheral surface of the electrostatic latent image holding body.

The image formation sequence in the electrophotographic apparatus having the above-described structure is described by taking a full color mode as an example. When the electrostatic latent image holding body 1 rotates in the arrow direction, the surface of the electrostatic latent image holding body is uniformly charged by the charge unit 8. Subsequently, a laser beam modulated by a black image signal of an original (not shown) passes through the writing unit 9 to form an electrostatic latent image on the electrostatic latent image holding body 1 and the electrostatic latent image is developed by the black developing machine 2.

On the other hand, a transfer sheet transported through the paper feed roller 17 or 18 and the paper guide 19 or 20 from the paper feed tray 15 or 16 electrostatically winds around the transfer drum 10 by the electrode 24 opposing the contacting roller 23. The transfer drum 10 is rotating in the arrow direction synchronously with the electrostatic latent image holding body 1 and the image developed by the black developing machine 2 is transferred by the transfer unit 11 at the position where the outer peripheral surface of the electrostatic latent image holding body 1 comes into contact with the outer peripheral surface of the transfer drum 10. The transfer drum continues rotating and stands by for the transfer of next color (magenta in FIG. 1).

The electrostatic latent image holding body 1 is liberated from the electrification by an electrification removing charge unit (not shown), cleaned by the cleaning unit 12, again uniformly charged by the charge unit 8, image exposed based on the next magenta image signal to form an electrostatic latent image, and developed by the magenta developing machine 3 to form a developed image. Subsequently, a developed cyan image and a developed yellow image are formed in the same manner. After the completion of transfer of four color portions, the multi-color developed image formed on the transfer sheet is liberated from the electrification by the charge unit 21, transported to the fixing unit 14 by the paper transportation unit 13, and fixed under heat and pressure, thereby completing the sequence of full color image formation in series.

The main part of the fixing unit 14 consists of a heat roller 14a and a pressure roller 14b each having a similar structure. The heat roller 14a has a quartz lamp of 500 W in the inside thereof and consists of a substrate roll comprising a steel-made core material having an outer diameter of 44 mmφ, and a fluorine-base rubber (for example, BAITON RUBBER produced by Du Pont) having a rubber hardness in terms of JIS hardness of 60 and a thickness of 40 μm provided on the substrate roll through an appropriate primer. The pressure roller 14b has a similar structure and consists of a substrate roll comprising a steel-made core material having an outer diameter of 48 mmφand a 1 mm-thick silicone rubber-made elastic layer provided on the substrate roll, with the remaining being thoroughly the same as in the structure of the heat roller 14a.

The heat roller is contacted with a silicone rubber-made oil donor roll as a releasing agent supply means for supplying a releasing agent comprising dimethyl polysiloxane having a functional group (e.g., amino group), so that the fluororubber surface can be modified into a highly releasable surface. The releasing agent is supplied to the oil donor roll from an oil pickup roll dipped in an oil pan.

The heat roller 14a and the pressure roller 14b are press-contacted by a pressurization mechanism to form a nick width of 6 mm at the center part. Both rollers are controlled to have a surface temperature of 150° C. and rotated in respective arrow directions each to give a surface speed of 160 mm/sec. In the case of the sheet having a basis weight in excess of 105 g/m², the rollers are rotated each to give a surface speed of 60 mm/sec.

The present invention is described in greater detail by referring to the Examples, however, the present invention should not be construed as being limited thereto. Unless otherwise indicated, the “parts” and “%” in the Examples and Comparative Examples are “parts by weight as a solid content” and “% by weight”, respectively.

### EXAMPLE 1

Preparation of Resin Mixed Solution

Aqueous polyurethane resin 100 parts (NeoRez R-967, produced by Zenaka KK)

Higher fatty acid amide-base bubble 5 parts conditioner (DC-100A, produced by Sanopco KK)

Carboxymethyl cellulose for adjusting 3 parts viscosity (for thickening) (AG gum, produced by Daiichi Kogyo Seiyaku KK)

The resin mixed solution (concentration as a solid content: 30%) having the above-described composition was subjected to foaming treatment by stirring the solution at a stirring rate of 490 rpm for 3 minutes using a stirrer (KENMIX AIKO PRO, manufactured by Aiko-Sha Seisakusho KK).

Preparation of Transfer Sheet

Immediately after the foaming, the bubble-containing resin mixed solution was coated on the surface of a wood free paper having a basis weight of 70 g/m² using an applicator to have a (dry) coated amount of 10 g/m² and then dried such that the sheet had a moisture content immediately after unsealing of 5.0%, to form a porous coated layer. Thus, a transfer sheet of Example 1 was prepared. This transfer sheet was measured on the volume of voids having a pore diameter of 10 μm or more by a mercury press fitting method and the void volume was found to be 7 ml/m². Further, the CD stiffness was measured by the Clarke's method according to JIS P8143 and found to be 40.2 cm²/100.

Preparation of Color Toner

A cyan color toner was prepared by mixing 96 parts of polyester resin, 1 part of a charge controlling agent and 3 parts of a cyan pigment. The magenta, yellow and black toners were prepared in the same manner using a magenta pigment, a yellow pigment and a black pigment, respectively, in place of the cyan pigment in the cyan toner. The thus-obtained cyan toner, magenta toner, yellow toner and black toner had a volume average particle size D₅₀ of 7 μm.

Image Revealing Test

An image revealing test was performed in an environment of 22° C. and 55% by applying the transfer sheet and color toners prepared above to the electrophotographic apparatus shown in FIG. 1. The electrophotographic apparatus was controlled to present image revealing conditions such that in the area of input dot area ratio being 100% on the transfer sheet, the amount of the black toner was 1.0 mg/cm² and the amount of each of the yellow, magenta and cyan toners was 0.65 mg/cm². The evaluation chart used for the revealing of an image had primary colors of yellow, magenta and cyan, secondary colors of red, green and blue, and tertiary colors of yellow, magenta and cyan, in which the colors had a dot area ratio varying from 0 to 100%.

Maximum Value of Image Glossiness and Gloss Difference (Maximum Glossiness—Minimum Glossiness) (%)

Glossiness at an incident angle of 75° was measured on the area having a highest glossiness including the white background area and on the area having a lowest glossiness, using a digital variable angle glossimeter according to JIS Z8741. The maximum glossiness and the minimum glossiness on the image area were determined and the difference therebetween was shown as the gloss difference.

Image Height from Sheet Surface (μm)

The height of the toner image after fixing was determined using a surface shape measuring microscope VF7500 manufactured by Keyence KK. The difference in the height level of the coated layer surface between the fixed image area with 100% of tertiary colors and the non-image area was determined and used as the image height. The value shown is an average of measurement values at five portions.

Graininess

The graininess was evaluated by visually judging the fixed image. Graininess equal to that of the JD paper which is an electrophotographic sheet produced by Fuji Xerox Corp. was Δ, better was ◯, and inferior was X.

Judgement of Discharge Mark

A transfer sheet was left standing in an environment of 10° C. and 15% for 10 hours or more and then subjected to an image revealing test in the same manner as above. The discharge mark was judged by rating those having generation of discharge marks as X and no generation of discharge marks as ◯.

Judgement of Transfer Failure

The transfer failure was evaluated by visually judging the fixed image. Those having no generation of transfer missing were ◯, and having generation of transfer missing were X.

Winding Around and Sticking to Fixing Unit

The winding around and sticking to the fixing unit were evaluated using the chart described above by visually judging whether a transfer sheet actually wound around the fixing unit and whether traces of sticking remained on the transfer sheet.

Results of Example 1

As a result of evaluation on these items, the transfer sheet of Example 1 was judged good, seeing that that the maximum glossiness was 35%, the gloss difference was 12%, the image height was 2 μm, the graininess was rated ◯, discharge marks were not generated, transfer failure did not occur, and the sheet did not wind around the fixing unit and was free of traces of sticking to the fixing unit.

### EXAMPLE 2

A resin mixed solution having the same composition as in Example 1 was stirred at 490 rpm for 10 minutes in the same stirrer as used in Example 1. After the foaming, the bubble-containing solution was left standing for 5 minutes, then coated on the surface of a wood free paper having a basis weight of 80 g/m² by means of an applicator bar to have a (dry) coated amount of 10 g/m², and dried to have a sheet moisture content of 5.0%, thereby forming a porous coated layer. Thus, a transfer sheet of Example 2 was prepared. This transfer sheet was measured and it was found that the volume of voids having a pore diameter of 10 μm or more was 12 ml/m² and the CD stiffness was 53.6 cm³/100.

The transfer sheet of Example 2 was evaluated in the same manner as in Example 1 and judged good, seeing that the maximum glossiness was 30%, the gloss difference was as small as 10%, the image height was 0.5 μm, the graininess was rated 0, discharge marks were not generated, transfer failure did not occur, and the sheet did not wind around the fixing unit and was free of traces of sticking to the fixing unit.

### EXAMPLE 3

A resin mixed solution having the same composition as in Example 1 was stirred at 490 rpm for 10 minutes in the same stirrer as used in Example 1. After the foaming, the bubble-containing solution was left standing for 12 minutes, then coated on the surface of a wood free paper having a basis weight of 80 g/m² by means of an applicator bar to have a (dry) coated amount of 10 g/m², and dried to have a sheet moisture content of 4.5%, thereby forming a porous coated layer. Thus, a transfer sheet of Example 3 was prepared. This transfer sheet was measured and it was found. that the volume of voids having a pore diameter of 10 μm or more was 35 ml/m² and the CD stiffness was 55.5 cm³/100.

The transfer sheet of Example 3 was evaluated in the same manner as in Example 1 and judged good, seeing that the maximum glossiness was 26%, the gloss difference was as small as 8%, the image height was 0.5 μm, the graininess was rated ◯, discharge marks were not generated, transfer failure did not occur, and the sheet did not wind around the fixing unit and was free of traces of sticking to the fixing unit.

### EXAMPLE 4

A resin mixed solution having the same composition as in Example 1 was stirred at 490 rpm for 20 minutes in the same stirrer as used in Example 1. After the foaming, the bubble-containing solution was left standing for 12 minutes, then coated on the surface of a wood free paper having a basis weight of 80 g/m² by means of an applicator bar to have a (dry) coated amount of 15 g/m², and dried to have a sheet moisture content of 4.5%, thereby forming a porous coated layer. Thus, a transfer sheet of Example 4 was prepared. This transfer sheet was measured and it was found that the volume of voids having a pore diameter of 10 μm or more was 50 ml/m² and the CD stiffness was 56.4 cm³/100.

The transfer sheet of Example 4 was evaluated in the same manner as in Example 1 and judged good, seeing that the maximum glossiness was 20%, the gloss difference was as small as 7%, the image height was 0.5 μm, the graininess was rated ◯, discharge marks were not generated, transfer failure did not occur, and the sheet did not wind around the fixing unit and was free of traces of sticking to the fixing unit.

### EXAMPLE 5

A resin mixed solution having the same composition as in Example 1 was stirred at 450 rpm for 10 minutes in the same stirrer as used in Example 1. Immediately after the foaming, the bubble-containing solution was coated on the surface of a wood free paper having a basis weight of 127 g/m² by means of an applicator bar to have a (dry) coated amount of 7 g/m², and dried to have a sheet moisture content of 4.5%, thereby forming a porous coated layer. Thus, a transfer sheet of Example 5 was prepared. This transfer sheet was measured and it was found that the volume of voids having a pore diameter of 10 μm or more was 7 ml/m² and the CD stiffness was 92.6 cm³/100.

The transfer sheet of Example 5 was evaluated in the same manner as in Example 1 and judged good, seeing that the maximum glossiness was 35%, the gloss difference was 30%, the image height was 2 μm, the graininess was rated ◯, discharge marks were not generated, transfer failure did not occur, and the sheet did not wind around the fixing unit and was free of traces of sticking to the fixing unit.

### EXAMPLE 6

A resin mixed solution having the same composition as in Example 1 was stirred at 450 rpm for 10 minutes in the same stirrer as used in Example 1. Immediately after the foaming, the bubble-containing solution was coated on the surface of a wood free paper having a basis weight of 127 g/m² by means of an applicator bar to have a (dry) coated amount of 15 g/m², and dried to have a sheet moisture content of 6.0%, thereby forming a porous coated layer. Thus, a transfer sheet of Example 6 was prepared. This transfer sheet was measured and it was found that the volume of voids having a pore diameter of 10 μm or more was 35 ml/m² and the CD stiffness was 81.2 cm³/100.

The transfer sheet of Example 6 was evaluated in the same manner as in Example 1 and judged good, seeing that the maximum glossiness was as small as 28%, the gloss difference was 23%, the image height was 0.5 μm, the graininess was rated ◯, discharge marks were not generated, transfer failure did not occur, and the sheet did not wind around the fixing unit and was free of traces of sticking to the fixing unit.

### COMPARATIVE EXAMPLE 1

A resin mixed solution having the same composition as in Example 1 was not subjected to the foaming treatment but coated as it is on the surface of a wood free paper having a basis weight of 80 g/m² by means of an applicator bar to have a (dry) coated amount of 10 g/m², and dried to have a sheet moisture content of 5.0%, thereby preparing a transfer sheet of Comparative Example 1. This transfer sheet was measured and it was found that the volume of voids having a pore diameter of 10 μm or more was 2 ml/m² and the CD stiffness was 43.3 cm³/100.

The transfer sheet of Comparative Example 1 was evaluated in the same manner as in Example 1. As a result, the maximum glossiness was 67%, the gloss difference was as large as 40%, the image height was as high as 15 μm, and the graininess was rated X. Discharge marks were not generated, transfer failure did not occur, and the sheet did not wind around the fixing unit and was free of traces of sticking to the fixing unit.

### COMPARATIVE EXAMPLE 2

A resin mixed solution having the same composition as in Example 1 was stirred at 490 rpm for 30 minutes in the same stirrer as used in Example 1. After the foaming, the bubble-containing solution was left standing for 5 minutes, then coated on the surface of a wood free paper having a basis weight of 80 g/m² by means of an applicator bar to have a (dry) coated amount of 10 g/m², and dried to have a sheet moisture content of 6.0%, thereby forming a porous coated layer. Thus, a transfer sheet of Comparative Example 2 was prepared. This transfer sheet was measured and it was found that the volume of voids having a pore diameter of 10 μm or more was 60 ml/m² and the CD stiffness was 56.4 cm³/100.

The transfer sheet of Comparative Example 2 was evaluated in the same manner as in Example 1. As a result, the maximum glossiness was 17%, the gloss difference was as small as 7%, the image height was 0.5 μm, and the graininess was rated A, but discharge marks were generated. Transfer failure did not occur and the sheet did not wind around the fixing unit and was free of traces of sticking to the fixing unit.

### COMPARATIVE EXAMPLE 3

A resin mixed solution having the same composition as in Example 1 was stirred at 490 rpm for 10 minutes in the same stirrer as used in Example 1. After the foaming, the bubble-containing solution was left standing for 5 minutes, then coated on the surface of a wood free paper having a basis weight of 65 g/m² by means of an applicator bar to have a (dry) coated amount of 10 g/m², and dried to have a sheet moisture content of 5.0%, thereby forming a porous coated layer. Thus, a transfer sheet of Comparative Example 3 was prepared. This transfer sheet was measured and it was found that the volume of voids having a pore diameter of 10 μm or more was 12 ml/m² and the CD stiffness was 33.8 cm³/100.

The transfer sheet of Comparative Example 3 was evaluated in the same manner as in Example 1. As a result, the maximum glossiness was 30%, the gloss difference was as small as 10%, the image height was 0.5 μm, the graininess was rated ◯, and discharge marks were not generated, but gloss unevenness was generated on the image area due to traces of sticking to the fixing unit.

### COMPARATIVE EXAMPLE 4

A commercially available electrophotographic transfer sheet (JD paper, an electrophotographic transfer sheet produced by Fuji Xerox Corp.) was used as it is. This transfer sheet was measured and it was found that the volume of voids having a pore diameter of 10 μm or more was 4.8 ml/m² the CD stiffness was 74.1 cm³/100, and the sheet moisture content was 4.7%.

The transfer sheet of Comparative Example 4 was evaluated in the same manner as in Example 1. As a result, the maximum glossiness was 50%, the gloss difference was as large as 40%, and the image height was as high as 10 μm. The graininess was rated Δ, discharge marks were not generated, transfer failure did not occur, and the sheet did not wind around the fixing unit and was free of traces of sticking to the fixing unit.

### COMPARATIVE EXAMPLE 5

A resin mixed solution having the same composition as in Example 1 was stirred at 450 rpm for 10 minutes in the same stirrer as used in Example 1. Immediately after the foaming, the bubble-containing solution was coated on the surface of a wood free paper having a basis weight of 127 g/m² by means of an applicator bar to have a (dry) coated amount of 7 g/m², and dried to have a sheet moisture content of 4.0%, thereby forming a porous coated layer. Thus, a transfer sheet of Comparative Example 5 was prepared. This transfer sheet was measured and it was found that the volume of voids having a pore diameter of 10 μm or more was 7 ml/m² and the CD stiffness was 80.0 cm³/100.

The transfer sheet of Comparative Example 5 was evaluated in the same manner as in Example 1. As a result, the maximum glossiness was as large as 35%, the gloss difference was 30%, the image height was 2 μm, and the graininess was rated ◯, but discharge marks were generated. Transfer failure did not occur and the sheet did not wind around the fixing unit and was free of traces of sticking to the fixing unit.

### COMPARATIVE EXAMPLE 6

A resin mixed solution having the same composition as in Example 1 was stirred at 450 rpm for 10 minutes in the same stirrer as used in Example 1. Immediately after the foaming, the bubble-containing solution was coated on the surface of a wood free paper having a basis weight of 127 g/m² by means of an applicator bar to have a (dry) coated amount of 7 g/m², and dried to have a sheet moisture content of 6.5%, thereby forming a porous coated layer. Thus, a transfer sheet of Comparative Example 6 was prepared. This transfer sheet was measured and it was found that the volume of voids having a pore diameter of 10 pm or more was 7 ml/m² and the CD stiffness was 80.0 cm³/100.

The transfer sheet of Comparative Example 6 was evaluated in the same manner as in Example 1. As a result, the maximum glossiness was 34%, the gloss difference was 29%, the image height was 2 μm, the graininess was rated ◯, and discharge marks were not generated, but transfer missing occurred. The sheet did not wind around the fixing unit and was free of traces of sticking to the fixing unit.

TABLE 1

| | Example 1 | Example 2 | Example 3 | Example 4 | Example 5 | Example 6 |
|---|---|---|---|---|---|---|
| Volume of voids having pore size of | 7 | 12 | 35 | 50 | 7 | 35 |
| 10 μm or more (ml/m²) | | | | | | |
| CD stiffness (cm³/100) | 40.2 | 53.6 | 55.5 | 56.4 | 92.6 | 81.2 |
| Moisture content immediately after | 5.0 | 5.0 | 4.5 | 4.5 | 4.5 | 6.0 |
| unsealing of sheet (%) | | | | | | |
| Maximum glossiness (%) | 35 | 30 | 26 | 20 | 35 | 28 |
| Gloss difference (maximum | 12 | 10 | 8 | 7 | 30 | 23 |
| glossiness - minimum glossiness) | | | | | | |
| (%) | | | | | | |
| Image height from sheet surface | 2 | 0.5 | 0.5 | 0.5 | 2 | 0.5 |
| (μm) | | | | | | |
| Graininess | ◯ | ◯ | ◯ | ◯ | ◯ | ◯ |
| Discharge mark | ◯ | ◯ | ◯ | ◯ | ◯ | ◯ |
| Transfer failure | ◯ | ◯ | ◯ | ◯ | ◯ | ◯ |
| Winding around · sticking to fixing | not | not | not | not | not | not |
| unit | generated | generated | generated | generated | generated | generated |

TABLE 2

| | Comparative | Comparative | Comparative | Comparative | Comparative | Comparative |
|---|---|---|---|---|---|---|
| | Example 1 | Example 2 | Example 3 | Example 4 | Example 5 | Example 6 |
| Volume of voids having pore size of | 2 | 60 | 12 | 4.8 | 7 | 7 |
| 10 μm or more (ml/m²) | | | | | | |
| CD stiffness (cm³/100) | 43.3 | 56.4 | 33.8 | 74.1 | 80.0 | 80.0 |
| Moisture content immediately after | 5.0 | 6.0 | 5.0 | 4.7 | 4.0 | 6.5 |
| unsealing of sheet (%) | | | | | | |
| Maximum glossiness (%) | 67 | 17 | 30 | 50 | 35 | 34 |
| Gloss difference (maximum | 40 | 7 | 10 | 40 | 30 | 29 |
| glossiness - minimum glossiness) | | | | | | |
| (%) | | | | | | |
| Image height from sheet surface | 15 | 0.5 | 0.5 | 10 | 2 | 2 |
| (μm) | | | | | | |
| Graininess | X | Δ | ◯ | Δ | ◯ | ◯ |
| Discharge mark (10° C., 15% RH) | ◯ | X | ◯ | ◯ | X | ◯ |
| Transfer failure (22° C., 55% RH) | ◯ | ◯ | ◯ | ◯ | ◯ | ◯ |
| Winding around · sticking to fixing | not | not | generated | not | not | not |
| unit | generated | generated | | generated | generated | generated |

According to the present invention having a constitution described in the foregoing, an electrophotographic transfer sheet free of winding around or sticking to a fixing unit and having excellent travelling stability can be provided. The image formed on the transfer sheet by a copying machine or printer for full color electrophotographing can have uniform gloss on the image surface, can be reduced in the image gloss, can be eliminated from the strange feeling due to toner height on the image, can have excellent graininess and can be prevented from generation of discharge marks in a low humidity environment.

While the invention has been described in detail and with reference to specific embodiments thereof, it will be apparent to one skilled in the art that various changes and modifications can be made therein without departing from the spirit and scope thereof.

What is claimed is:

1. An electrophotographic transfer sheet comprising:
a support having on at least one surface thereof a porous coating layer formed of a resin, wherein
the volume of voids having a pore size of 10 μm or more determined by a mercury press fitting method is from 7 to 50 ml/m².

2. The electrophotographic transfer sheet as claimed in claim 1, wherein
the CD stiffness determined by the Clark method according to JIS P8143 is 40 cm³/100 or more.

3. The electrophotographic transfer sheet as claimed in claim 1, wherein
the moisture content immediately after unsealing according to JIS P8127 is from 4.5 to 6.0%.

4. A method for forming a full color image comprising the steps of:
transferring, and
fixing a toner image on an electrophotographic transfer sheet comprising a support having on at least one surface thereof a porous coating layer formed of a resin, wherein
said electrophotographic transfer sheet is a transfer sheet of claim 1,
the image on said transfer sheet after the transferring and the fixing under pressure and heat has a maximum glossiness of 35% or less,
a gloss difference (maximum glossiness—minimum glossiness) is 30% or less, and
a toner image height is 2 μm or less.
